(19) United States
(12) Patent Application Publication
(10) Pub. No.: US 2013/0168422 A1
(43) Pub. Date: Jul. 4, 2013

(54) UPPER-BODY INFANT BONDING GARMENT

(71) Applicant: Chelsea Carbonell, Snoqualmie, WA (US)

(72) Inventor: Chelsea Carbonell, Snoqualmie, WA (US)

(21) Appl. No.: 13/342,108

(22) Filed: Jan. 1, 2012

(51) Int. Cl. A61G 1/00

(52) U.S. Cl. 224/158

(57) ABSTRACT

An upper-body garment comprised mostly of stretchy, breathable fabric designed to promote bonding between parent and child and enable both to sleep. The garment may also be comprised of netting or mesh fabric. The garment is designed to allow both parent and child to lie down and sleep safely and securely together. The garment has a zipper on the front portion to open and close the garment so that a child may be zipped into the garment with the adult. The garment has a square-neckline designed to position a child laying face down on the sternum of a supine adult and to expose at least the head and arms of the child. The garment may have a flap on the front portion which covers the zipper pull. The garment may also have buttons, snaps, or hook and loop as a fastener.

### FIELD OF INVENTION

This invention relates generally to clothing, and more particularly to an upper-body infant bonding garment.

### BACKGROUND

The first few months of a child's life are the most important to create a lasting bond between parent and child. One of the best ways for a parent and child to bond is through skin to skin contact. Sleep is also important for a newborn child and the parents, and when the newborn child does not sleep, the parents have difficulty sleeping as well. The majority of young children prefer to sleep on the parent's chest because it enables the child to hear the parent's heartbeat and it is reminiscent of the mother's womb. Also, young children enjoy the scent of the parent. Unfortunately, parent and child cannot sleep together easily. Many co-sleepers available on the market are designed to have the baby sleep separately from the adult and none of these co-sleepers allow for bonding time between parent and child. Furthermore, none of these co-sleepers are wearable.

The only garments which provide secure support for the child are baby slings, and other similar devices, which cannot be used safely while both parent and child are sleeping. What is needed is an article of clothing capable of allowing adult and child to sleep together safely and securely while still providing the necessary closeness for the adult and child to bond.

Consequently, this invention relates generally to clothing, and more particularly to an upper-body infant bonding garment.

### SUMMARY

This invention relates generally to clothing, and more particularly to an upper-body infant bonding garment. In some embodiments, the upper-body infant bonding garment is worn by an adult and used to hold a child prone against the chest of a supine adult. The upper-body infant bonding garment is designed to keep the head of the child against the sternum of the adult, so that the child can hear the heartbeat emanating from the heart of the adult.

In some embodiments, the upper-body infant bonding garment is manufactured of breathable, stretchable fabric operable to secure the child to the chest of the adult. The fabric may also be comprised in part of netting or mesh.

In some embodiments, the upper-body infant bonding garment has a front portion, wherein the front portion at least partially opens from the neckline down the middle of the garment to form an opening sufficient to permit a child to pass into the interior of the garment.

In some embodiments, the front portion has a fastener operable to couple the first side and the second side of the upper-body infant bonding garment. The fastener may be a zipper, snaps, button, hook-and-loop style closures, or any other type of fastener.

In some embodiments, at least a portion of the interior of the first side of the front portion forms a flap to overlay the exterior of the second side and cover a portion of the fastener. The flap is designed to protect the baby's head and arms from the fastener. The flap may be fastened by a hook-and-loop style closure to the exterior of the second side.

### BRIEF DESCRIPTION OF THE DRAWINGS

Embodiments of the present invention are described in detail below with reference to the following drawings:

FIG. 1 is a top view of an upper-body infant bonding garment, in accordance with an embodiment of the invention;

FIG. 2 is a perspective view of an upper-body infant bonding garment, in accordance with an embodiment of the invention;

FIG. 3 is a perspective view of an upper-body infant bonding garment, in accordance with an embodiment of the invention;

FIG. 4 is a front view of an upper-body infant bonding garment, in accordance with an embodiment of the invention;

FIG. 5 is a rear view of an upper-body infant bonding garment, in accordance with an embodiment of the invention;

FIG. 6 is a side view of an upper-body infant bonding garment, in accordance with an embodiment of the invention; and

FIGS. 7, 8 and 9 are front views of an upper-body infant bonding garment, in accordance with embodiments of the invention.

### DETAILED DESCRIPTION

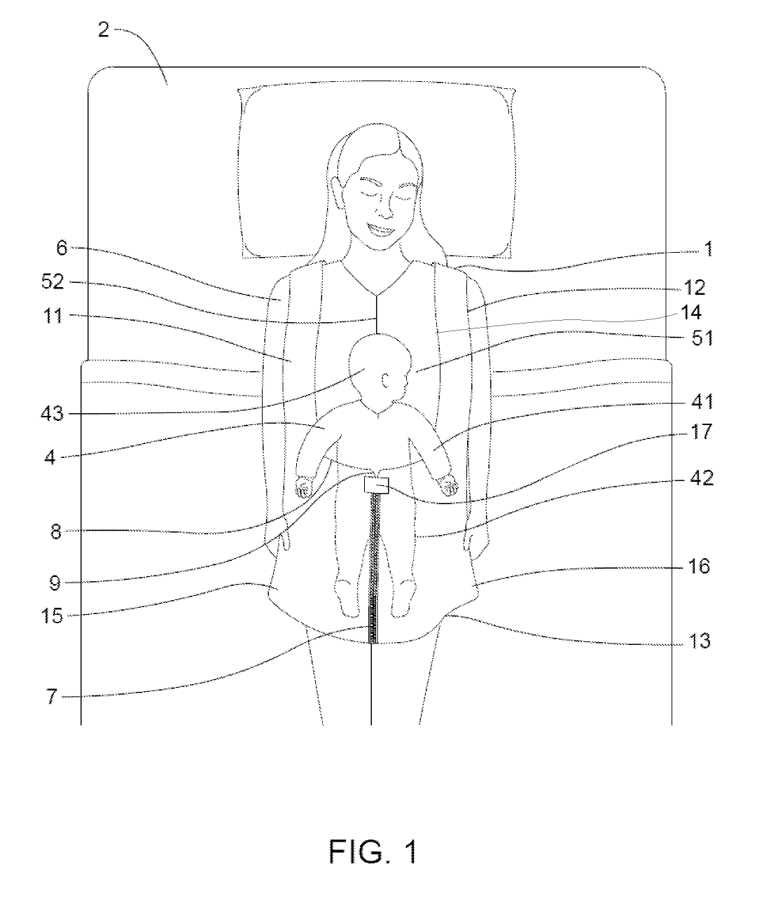

This invention relates generally to clothing, and more particularly to an upper-body infant bonding garment. Specific details of certain embodiments of the invention are set forth in the following description and in FIGS. 1-9 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a top view of an upper-body infant bonding garment, in accordance with an embodiment of the invention. In some embodiments, an upper-body infant bonding garment 1 is worn by an adult 5 and used to hold a child 4 prone against the chest of the supine adult 5. The upper-body infant bonding garment 1 may be used for a newborn infant up until the child no longer fits. In some embodiments, the supine adult 5 lays on a bed 2. In different embodiments, the supine adult 5 may lay on a couch or a recliner or on any other structure on which the adult 5 can lay supine.

In some embodiments, an upper-body infant bonding garment 1 is designed to keep the head 43 of the child 4 against the sternum 52 of the adult 5, so that the child 4 can hear the heartbeat emanating from the heart 51 of the adult 5.

In some embodiments, an upper-body infant bonding garment 1 has a front portion 11 and a rear portion (rear portion not pictured in FIG. 1), the front portion 11 and rear portion forming a garment with an interior and an exterior. The upper-body infant bonding garment 1 may have an aperture for the waist 13 of the adult 5, apertures for the arms 12 of the adult 5, and an aperture for the neck 14 of the adult 5. In some embodiments, an upper-body infant bonding garment 1 is a vest, wherein the apertures for the arms 12 of the adult 5 are adjacent to the chest of the adult 5. In different embodiments, an upper-body infant bonding garment 1 may be a shirt, either short-sleeve or long-sleeve, wherein the apertures for the arms 12 of the adult 5 are adjacent to the biceps or wrists of the adult 5.

In some embodiments, an upper-body infant bonding garment 1 has an aperture for the neck of the adult 14 that forms a neckline 8 of the front portion of the garment 11. The neckline 8 of the front portion 11 is positioned to expose at least the head 43 and arms 41 of the child 4, and to position the exposed head 43 of the child 4 on the sternum 52 of the adult 5. A child 4 thusly positioned can hear the heartbeat emanating from the heart 51 of the adult 5.

In some embodiments, an upper-body infant bonding garment 1 has a front portion 11, wherein the front portion 11 at least partially opens from the neckline 8 down the middle of the upper-body garment to form an opening 9, the opening 9 forming a first side 15 of the front portion and a second side 16 of the front portion. In some embodiments, the front portion 11 fully opens at the opening 9, from the neckline 8 down the middle of the upper-body infant bonding garment 1 to the aperture for the waist 13 of the adult 5. In different embodiments, the opening 9 does not open all the way to the aperture for the waist 13 of the adult 5 so that the front portion only partially opens from the neckline 8. In such embodiments, the opening 9 is still sufficient to permit a child 4 to pass into the interior of the garment.

In some embodiments, the front portion 11 has a fastener 7 operable to couple the at least partial opening 9 of the front portion 11, joining the first side 15 of the front portion 11 to the second side 16 of the front portion 11.

In some embodiments, the fastener 7 may be a zipper. In different embodiments, the fastener 7 may be snaps, buttons, hook-and-loop style closures, or any other fastener that is known in the art to be able to close an opening of a garment. In certain embodiments having a zipper for a fastener 7, the zipper may have a zipper pull, the zipper pull for pulling the zipper open and closed. In a particular embodiment, the zipper and zipper pull are made of material that is non-toxic so as to not harm a baby who happens to put its mouth on the zipper pull.

In some embodiments, the front portion 11 is manufactured of soft, breathable, stretchable fabric, the soft, breathable, stretchable fabric operable to secure the child in the prone position against the chest of the supine adult when the fastener 7 is employed to couple the front portion 11.

In some embodiments, at least a portion of the garment 1 is manufactured of netting or mesh fabric.

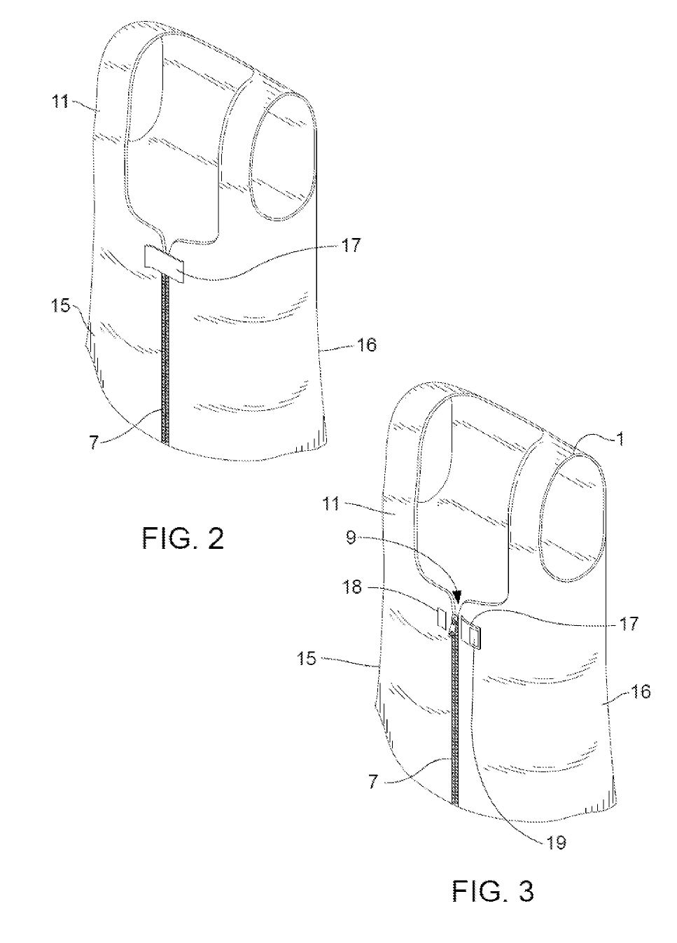

FIG. 2 is a perspective view of an upper-body infant bonding garment, in accordance with an embodiment of the invention. In some embodiments, a portion of the interior 17 of the first side 15 of the front portion 11 overlays the exterior of the second side 16, covering at least a portion of the fastener 7. In some embodiments, a portion of the interior 17 of the first side 15 of the front portion 11 is a flap, the flap operable to cover the top portion of the fastener 7, the top portion of the fastener 7 in some embodiments being a zipper pull that may be covered by the flap. In such embodiments, the zipper pull is inaccessible to the child.

FIG. 3 is a perspective view of an upper-body infant bonding garment, in accordance with an embodiment of the invention. In some embodiments, the front portion 11 has a fastener 7 operable to couple the at least partial opening 9 of the front portion 11, joining the first side 15 of the front portion 11 to the second side 16 of the front portion 11. In some embodiments, the fastener 7 may be a zipper. In certain embodiments having a zipper for a fastener 7, the zipper may have a zipper pull, the zipper pull for pulling the zipper open and closed. In a particular embodiment, the zipper and zipper pull are made of material that is non-toxic so as to not harm a baby who happens to put its mouth on the zipper pull.

In the preferred embodiment, a portion of the interior 17 of the front portion 11 forms a flap, the flap covering a portion of the zipper and the zipper pull. In some embodiments, the front portion 11 contains a hook and loop fastener on the first side 15 of the interior 17 (i.e. the flap). One half of the fastener 19 is located on the underside of the interior 17 and the other half of the fastener 18 is located on the opposite side of the second side 16 of the upper-body infant bonding garment 1 so as to provide a secure closure for the interior 17.

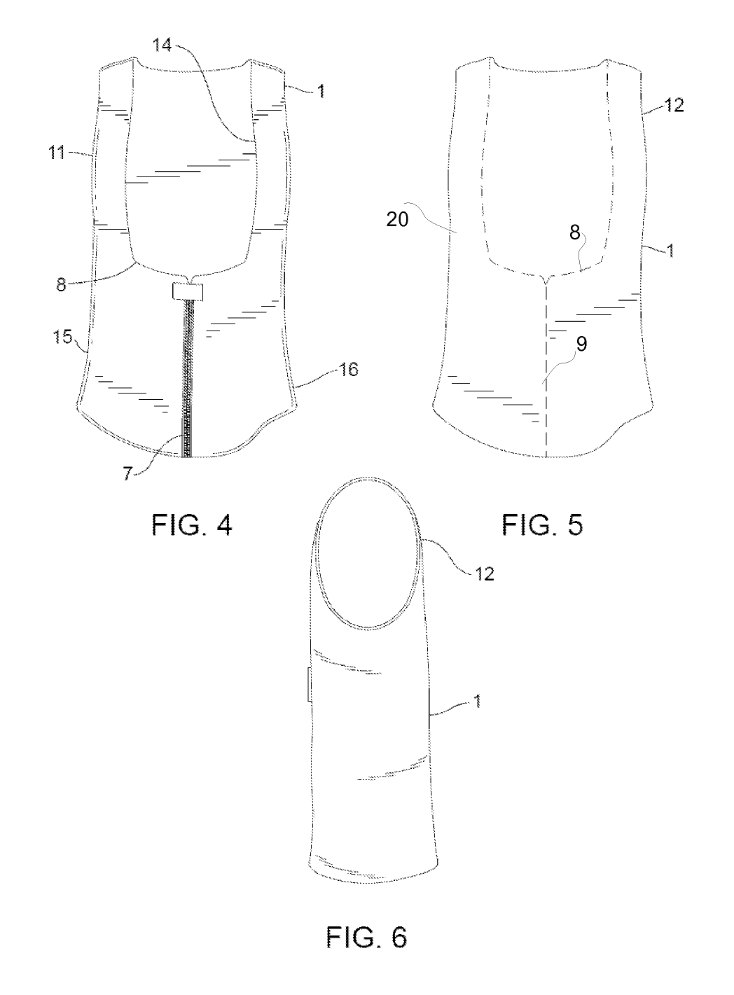

FIG. 4 is a front view of an upper-body infant bonding garment, in accordance with an embodiment of the invention. The neckline 8 at the bottom of the aperture for the neck of the adult 14 is formed when the first side 15 of the front 11 and second side 16 of the front 11 are fastened together by the fastener 7.

In some embodiments, an upper-body infant bonding garment 1 has an aperture for the neck of the adult 14 that forms a neckline 8 of the front portion of the garment 11. As seen and discussed in reference to FIG. 1, the neckline 8 of the front portion 11 is positioned to expose at least the head and arms of the child, and to position the exposed head of the child on the sternum of the adult.

In some embodiments, the fastener 7 may be a zipper. In different embodiments, the fastener 7 may be snaps, buttons, hook-and-loop style closures, or any other fastener that is known in the art to be able to close an opening of a garment. In certain embodiments having a zipper for a fastener 7, the zipper may have a zipper pull, the zipper pull for pulling the zipper open and closed. In a particular embodiment, the zipper and zipper pull are made of material that is non-toxic so as to not harm a baby who happens to put its mouth on the zipper pull.

FIG. 5 is a rear view of an upper-body infant bonding garment, in accordance with an embodiment of the invention. In some embodiments, the back portion 20 of the upper-body infant bonding garment 1 covers the entire back from the shoulders to the waist and has apertures for the arms 12. In FIG. 5, the neckline 8 of the front of the garment and opening in the front of the garment 9 are shown in broken lines.

FIG. 6 is a side view of an upper-body infant bonding garment, in accordance with an embodiment of the invention. The side of the upper-body infant bonding garment 1 is comprised of stretchable fabric and has apertures for the arms.

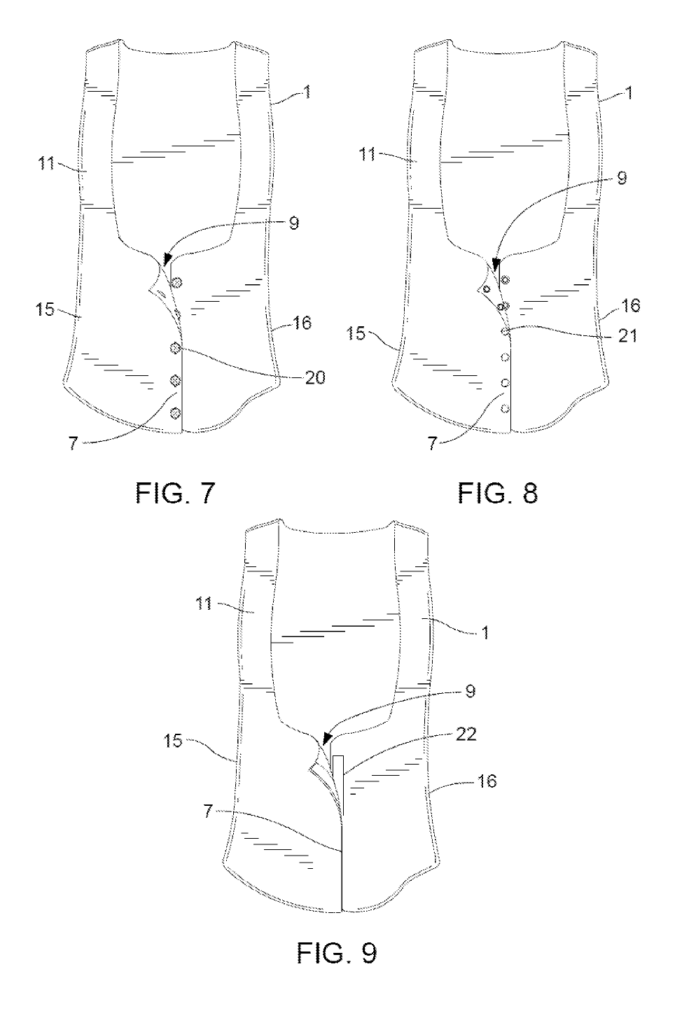

FIG. 7 is a front view of an upper-body infant bonding garment, in accordance with an embodiment of the invention. In some embodiments, the front portion 11 has a fastener 7 operable to couple the at least partial opening 9 of the front portion 11, joining the first side 15 of the front portion 11 to the second side 16 of the front portion 11. In some embodiments, the fastener 7 may be one or more buttons 20 which are evenly spaced up the front portion of the upper-body infant bonding garment 1.

FIG. 8 is a front view of an upper-body infant bonding garment, in accordance with an embodiment of the invention. In some embodiments, the front portion 11 has a fastener 7 operable to couple the at least partial opening 9 of the front portion 11, joining the first side 15 of the front portion 11 to the second side 16 of the front portion 11. In some embodiments, the fastener 7 may be one or more snaps 21, which are evenly spaced up the front portion 11 of the upper-body infant bonding garment 1.

FIG. 9 is a front view of an upper-body infant bonding garment, in accordance with an embodiment of the invention. In some embodiments, the front portion 11 has a fastener 7 operable to couple the at least partial opening 9 of the front portion 11, joining the first side 15 of the front portion 11 to the second side 16 of the front portion 11. In some embodiments, the fastener 7 may be a hook and loop fastener 22. The hook and loop fastener 22 extends on both the first side 15 and second side 16 from the bottom of the upper-body infant bonding garment 1 up to the neckline 8. The first side 15 overlaps the second side 16 to provide secure closure. In other embodiments, the hook and loop fastener 22 does not span the entire length of the front portion 11 of the upper-body infant bonding garment 1.

In the preferred embodiment, sizing of the garment may be for the average small, medium, large and extra-large sized post-partum female. Even though sizing is designed primarily for female use, adult males may also wear the garment. From the foregoing description, the upper body garment constructed according to the description is capable of providing secure contact between a human and infant of varying size.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments.

1.-2. (canceled)

3. The upper-body garment of claim 15 wherein the zipper and zipper pull are made of non-toxic material.

4. The upper-body garment of claim 13 wherein the front portion fully opens from the neckline down the middle of the upper-body garment to an aperture of the front portion of the garment for the waist of the adult.

5.-6. (canceled)

7. The upper-body garment of claim 13 wherein the fastener is one or more buttons.

8. The upper-body garment of claim 13 wherein the fastener is one or more snaps.

9. The upper-body garment of claim 13 wherein the fastener is a hook-and-loop style fastener.

10. The upper-body garment of claim 13 wherein at least a portion of the garment is manufactured of netting or mesh fabric.

11.-12. (canceled)

13. An upper-body garment for holding a child prone against the chest of a supine adult, comprising:
a front portion, the front portion including at least a neckline positioned to expose at least the head and arms of the child and to position the exposed head of the child on the sternum of the adult; and
a back portion, the back portion covering the back of the adult from shoulders to waist,
wherein the front portion at least partially opens from the neckline down the middle of the upper-body garment,
wherein the front portion has a fastener operable to couple the at least partial opening of the front portion,
wherein the front portion is comprised of stretchable fabric operable to secure the child in position when the fastener is closed,
wherein the upper-body garment comprises at least one of a vest, shirt, jacket, sweatshirt or sweater.

14. The upper-body garment of claim 13, wherein the fastener operable to couple the at least partial opening of the front portion comprises:
a zipper operable to couple the at least partial opening of the front portion.

15. The upper-body garment of claim 14, further comprising:
a flap, the flap configured to cover a zipper pull of the zipper, the flap being at least a part of the front portion of the upper-body garment, the flap covering a top portion of the zipper and operable to make the zipper pull inaccessible to the child.

16. The upper-body garment of claim 15, wherein the flap comprises:
a flap, the flap including at least one side of a hook and loop fastener, wherein an opposite side of the hook and loop fastener is affixed to the front portion of the upper-body garment, the hook and loop fastener operable to secure the flap in a closed position.

17. A method of holding a child prone against the chest of a supine adult, comprising:
obtaining an upper-body infant bonding garment, including at least:
a front portion, the front portion including at least a neckline positioned to expose at least the head and arms of the child and to position the exposed head of the child on the sternum of the adult, the front portion including at least an at least partial opening from the neckline down the middle of the garment, the front portion comprised of stretchable fabric operable to snugly secure the child in position when the at least partial opening is closed;
a back portion, the back portion covering the back of the adult from shoulders to waist;
a zipper operable to couple the at least partial opening of the front portion; and
a flap of the front portion, the flap including at least one side of a hook and loop fastener, wherein an opposite side of the hook and look fastener is affixed to the front portion of the garment for securing the flap in a closed position over a top portion of the zipper, the flap operable to make a zipper pull inaccessible to the child;
wearing the upper-body infant bonding garment;
placing a child against the chest, the child's head resting on the sternum;
closing the zipper of the upper-body infant bonding garment to snugly secure the child in position; and
securing the hook and loop fastener of the flap to the front portion of the garment.
